(19) United States
(12) Patent Application Publication
(10) Pub. No.: US 2004/0122750 A1
(43) Pub. Date: Jun. 24, 2004

(54) Delivery refusal retest and pack process for direct mail order computers

(75) Inventor: James L. Kroening, Dakota Dunes, SD (US)

Correspondence Address: GATEWAY, INC., ATTN: SCOTT CHARLES RICHARDSON, 610 GATEWAY DRIVE, MAIL DROP Y-04, NORTH SIOUX CITY, SD, 57049, US

(73) Assignee: Gateway, Inc.

(21) Appl. No.: 10/323,122

(22) Filed: Dec. 18, 2002

(51) Int. Cl. G06F 17/60

(52) U.S. Cl. 705/29

(57) ABSTRACT

The present invention is a system and method for referencing returned build to order configuration systems, which have been returned unopened, with a current backlog of purchase orders of a similar configuration. A returned build to order system may be scanned to detect its serial number information. A bill of materials for the returned system may be retrieved. The bill of materials, which may list each component of the build to order system, may be referenced with received purchase orders. When there is a match between the returned system and a purchase order, the system may be tested and repacked for shipping to the new customer.

### FIELD OF THE INVENTION

The present invention generally relates to the field of sales systems, and more particularly to a system and method for fulfilling purchase order requests of build to order systems with returned build to order configuration systems of a similar configuration.

### BACKGROUND OF THE INVENTION

Currently, consumers have a variety of choices regarding components of many products. For example, in the purchase of a computer, a consumer may select a particular type of processor, network card, memory, peripherals and the like. Typically, build to order systems must be assembled after receipt of a purchase order. Thus, a delay exists between the purchase of the system and receipt of the system after shipment. Due to this delay, a consumer may refuse delivery. Additionally consumers may change their decision regarding the purchase of the build to order system and may return the system.

When a build to order system has been returned, the customer's account is credited. If the system has been powered up by the user, or otherwise tampered with, the system is typically characterized as a refurbished system and may be resold at a reduced price after verifying that the system is in working order. However, if the box is returned unopened, or the system has not been powered up, used or otherwise tampered with, then, the system is typically disassembled and the parts of the system can be returned to stock where they may be re-used in the manufacture of another build to order system. The disassembly of returned computers is costly to a manufacturer. It would be advantageous if a returned system could be re-tested to ensure the system operates well and then sold to another consumer desirous of the same build to order system. Consequently, a system and method for referencing returned build to order configuration systems with a current backlog of purchase orders of a similar configuration is necessary.

### SUMMARY OF THE INVENTION

Accordingly, the present invention is directed to a system and method for referencing returned build to order configuration systems with a current backlog of purchase orders of a similar configuration. In an embodiment of the invention, a serial number of the returned system may be scanned. Detection of the serial number may allow retrieval of a bill of materials for the returned system. The bill of materials, which may list each component of the build to order system, may be referenced with received purchase orders. When there is a match between the returned system and a purchase order, the system may be tested and repacked for shipping to the new customer.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an embodiment of a process for selling a returned build to order system in accordance with the present invention;

FIG. 2 is an embodiment of a process for fulfilling a purchase order with a returned build to order system in accordance with the present invention;

FIG. 3 is an embodiment of a process for offering a returned build to order system to potential customers in accordance with the present invention;

FIG. 4 depicts a block diagram of a system for selling returned build to order systems in accordance with the present invention; and

FIG. 5 is a block diagram of an information handling system of the present invention.

### DETAILED DESCRIPTION OF THE INVENTION

Reference will now be made in detail to the presently preferred embodiments of the invention, examples of which are illustrated in the accompanying drawings.

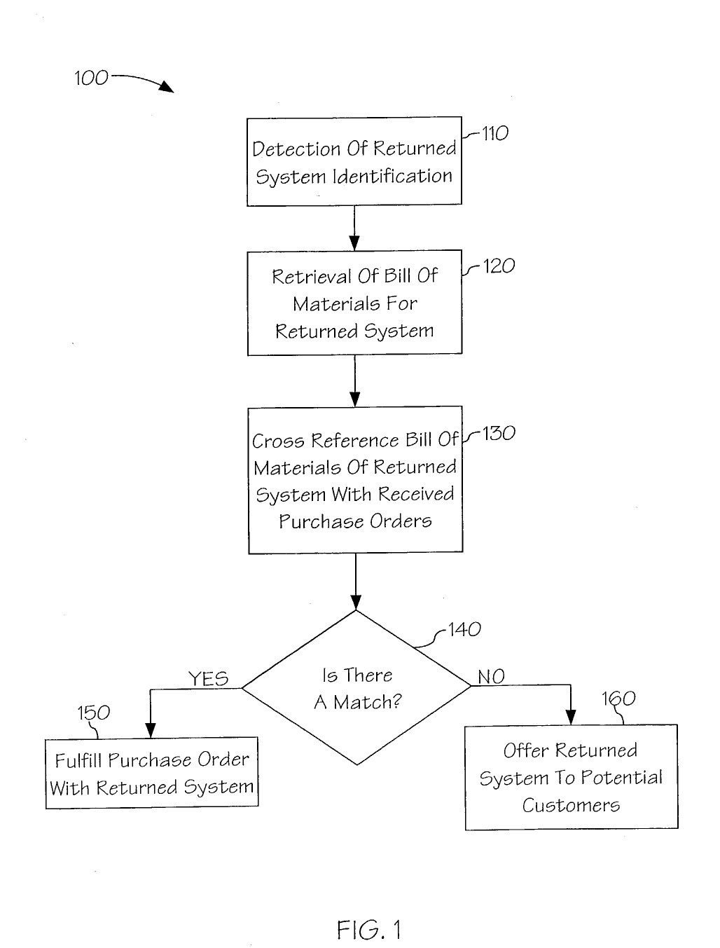

FIG. 1 depicts an embodiment of a process 100, in accordance with the present invention, for selling a returned build to order system which has not been powered up, used, or otherwise tampered with by the original purchaser. For ease of explanation, such a system—which has been verified to be unused—shall be hereinafter referred to as a returned system, a returned build to order system, or a delivery refusal. In the past, manufacturers of build to order systems have been required to disassemble returned build to order systems and place the parts into stock. This is costly to the manufacture. Process 100 of the present invention allows for easily fulfilling purchase orders with returned build to order systems.

Process 100 may begin by detection of an identification of a returned system 110. The step 110 may entail a procedure for verifying that the box of returned system was returned unopened, or the system has not been powered up, used or otherwise tampered with by the user who returned it. It is widely popular for manufacturers to identify products by including a serial number on the product and packaging of the product. This allows a manufacturer to easily maintain inventory and sales figures along with associating a particular customer with a particular build to order system. Often, the serial number of the product may include a bar code, a radio-frequency identification, or the like. Thus, when a product has been returned, the serial number may be detected by scanning a bar code, radio-frequency identification, and the like.

Detection of the identification of a returned system may be linked to an information handling system, which by connection with a network, may retrieve a bill of materials for the returned system 120. When a serial number is issued for a particular customer, it may include the customer's relevant information and a bill of materials for the build to order system. The bill of materials may include a list of components which have been included within the build to order system. The bill of materials of the returned system may be cross referenced with received purchase orders 130. When purchase orders are received, customer information and a list of desired components within the system may be included. The purchase orders that have been received may be compared with the configuration of the returned system to determine if there are any matches, for example, if the list of components of the returned system is the same as the list of components for a particular purchase order. A match may either be an exact match or an acceptably close match. If the lists of components are very similar, but do not match exactly, the closeness of the match may be evaluated using an estimated cost to reconfigure the returned system 150 to be an exact match of a purchase order. For example, based on the estimated costs it may be less expensive to reload a software package than to replace a CD disk drive with a 3½ inch floppy drive in the returned system 150. Similarly, it may be estimated to be less expensive to swap out two disk drives than to remove an extended memory set from the returned system 150. A match may be considered an acceptably close match if it costs less than a predetermined amount, or predetermined percentage, to reconfigure the returned system 150. If a match exists 140—either an exact match or an acceptably close match—then the matching purchase order may be fulfilled with the returned system 150. If a match does not exist, the returned system may be offered to potential customers 160, as is, with the possibility of offering a discount since the returned system is not an exact match.

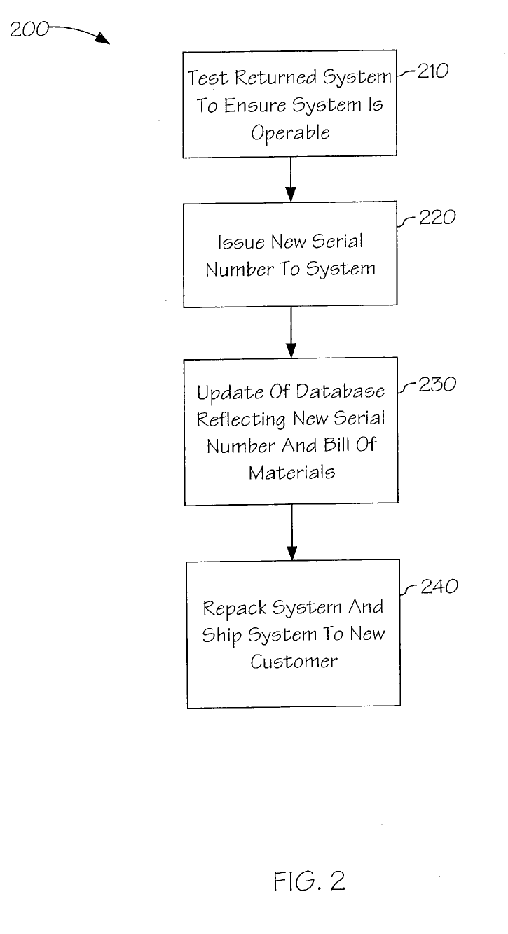

Referring now to FIG. 2, an embodiment of a process 200 for fulfilling a purchase order with a returned build to order system in accordance with the present invention is shown. Process 200 may be implemented when there has been a match found between the returned system and a particular purchase order as shown in FIG. 1. Process 200 may begin by testing the returned system to ensure the system is operable 210, even though it may be determined that the box is unopened or the user has not powered up or tampered with the system. This is done because the returned system may have been damaged when the system was shipped. Once the system is verified to be operable, a new serial number may be issued to the system 220. The new serial number may include information regarding the new customer and may also include the list of components within the build to order system. A database of the serial numbers may be updated reflecting the new serial number and the bill of materials 230. The system may be repacked and shipped to the new customer 240.

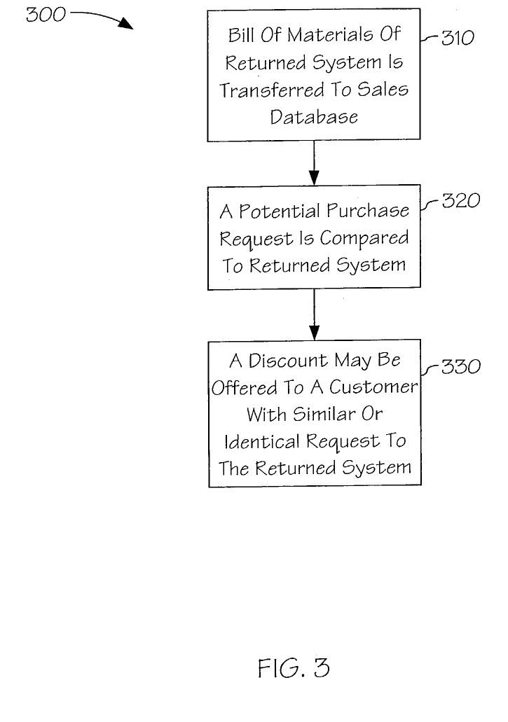

Referring to FIG. 3, an embodiment of a process 300 for offering a returned build to order system to potential customers in accordance with the present invention is shown. Process 300 may be implemented when there is not a match found between the returned system and a particular purchase order as shown in FIG. 1. Process 300 may begin by transferring a bill of materials of the returned system to a sales database 310. In the sale of build to order systems, sales representatives may refer to a sales database to aid them in the sale of build to order systems. For example, sales database may include inventory information, specifications of particular components, cost of particular components and the like. A potential purchase request may be compared to a returned system 320. When a customer is selecting components and features of a build to order system, a list of chosen items may be included in a shopping cart type of list. As a potential customer adds components to the build to order system, the list of components within the shopping cart may be compared with the list of components of the returned system.

A discount may be offered to the customer with a similar or identical request to the returned system 330. This may be advantageous as it may help a sales representative close a sale with a potential customer by offering a price break that can offset the costs associated with disassembling the build to order system and again entering the disassembled parts into inventory. Additionally, the customer may benefit by purchasing a system similar or identical to the desired build to order system at a lower cost than what otherwise could have been possible. If a potential customer agrees to the purchase of the returned system, process 200 of FIG. 2 may be executed to ensure that the system is operable and a new serial number is issued reflecting the new customer information.

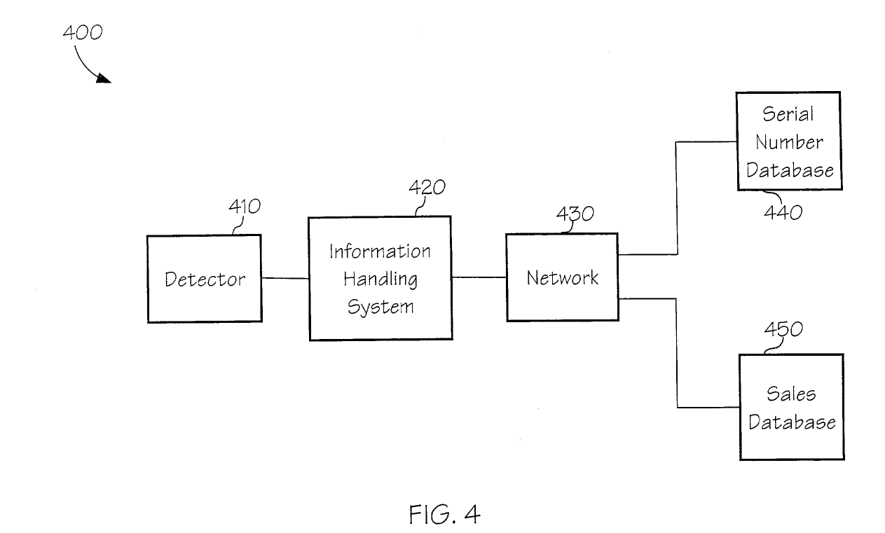

Referring to FIG. 4, a block diagram of a system 400 for selling returned build to order systems in accordance with the present invention is shown. System 400 of the present invention may implement processes 100, 200 and 300 of FIGS. 1-3 for selling returned build to order systems in accordance with the present invention. System 400 may include a detector 410, an information handling system 420, a network 430, a serial number database 440 and a sales database 450.

In one embodiment of the invention, detector 410 may be capable of applying a signal to a product identification marker such as a bar code to determine a serial number of a build to order system. In an alternative embodiment, detector 410 may receive a radio-frequency identification to ascertain a serial number of a build to order system. It should be understood by those with ordinary skill in the art that various types of detectors for reading a packet of data may be utilized in accordance with the present invention without departing from the scope and intent of the present invention.

Information handling system 420 may be coupled to detector 410. Information handling system may perform the functions of retrieving a bill of materials from a database for a particular serial number as described in FIG. 1 after transfer of the particular serial number from detector 410. Additionally, information handling system 420 may cross reference the bill of materials with received purchase orders. Information handling system 420 may be capable of interfacing with databases across a network 430. Network may be a local area network (LAN) or may be a worldwide network such as the Internet.

Serial number database 440 and sales database 450 may be accessed by information handling system 420 across a network 430. Serial number database may include a list of all serial numbers of sold systems along with a bill of materials and customer information. Sales database 450 may include customer information and a purchase order request information. While system 400 for selling build to order systems includes a network 430 coupled to a serial number database 440 and sales database 450, it is contemplated that serial number database 440 and sales database 450 may be implemented within an information handling system 420 without departing from the scope and intent of the present invention.

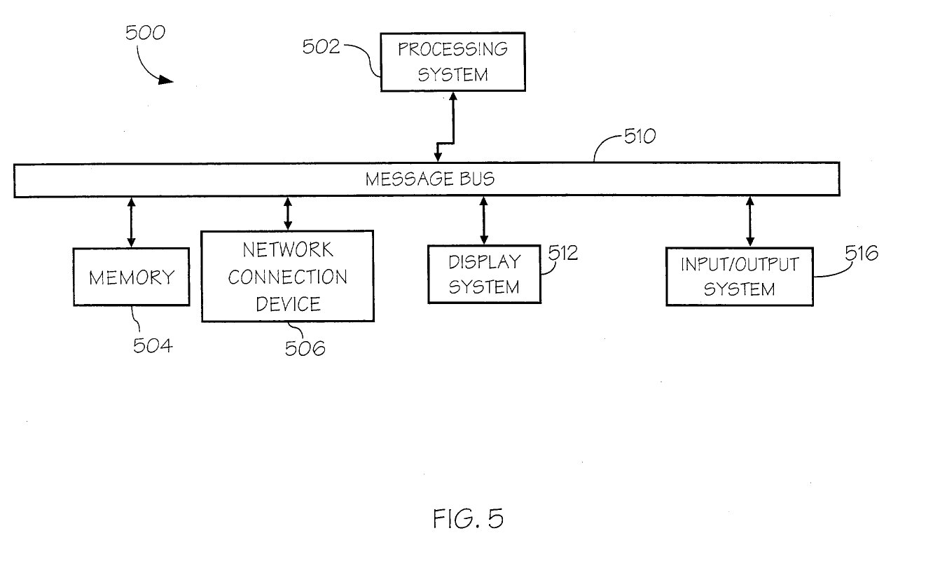

Referring now to FIG. 5, a hardware system in accordance with the present invention is shown. The hardware system shown in FIG. 5 is generally representative of a preferred hardware architecture of an information handling system 500 of the present invention. In one embodiment of the invention, information handling system 500 may be capable of performing steps of processes 100, 200, and 300 of the present invention depicted in FIGS. 1-3. For example, steps of processes 100, 200 and 300 may be implemented as a program of instructions executable by information handling system 500. A controller, for example, a processing system 502, controls the information handling system 500. The processing system 502 includes a central processing unit such as a microprocessor or microcontroller for executing programs, performing data manipulations and controlling the tasks of the information handling system 500. Communication with the processing system 502 may be implemented through a message or system bus 510 for transferring information among the devices of the information handling system 500. The system bus 510 may include a data channel for facilitating information transfer between storage and other peripheral devices of the information handling system 500. The system bus 510 further provides the set of signals required for communication with processing system 502 including a data bus, address bus, and control bus. The system bus 510 may comprise any state of the art bus architecture according to promulgated standards, for example industry standard architecture (ISA), extended industry standard architecture (EISA), Micro Channel Architecture (MCA), peripheral device interconnect (PCI) local bus, standards promulgated by the Institute of Electrical and Electronics Engineers (IEEE) including IEEE 488 general-purpose interface bus (GPIB), IEEE 696/S-600, and so on. Furthermore, the system bus 510 may be compliant with any promulgated industry standard. For example, the system bus 510 may be designed in compliance with any of the following bus architectures: Industry Standard Architecture (ISA), Extended Industry Standard Architecture (EISA), Micro Channel Architecture, Peripheral Device Interconnect (PCI), Universal Serial Bus (USB), Access bus, IEEE P6394, Apple Desktop Bus (ADB), Concentration Highway Interface (CHI), Fire Wire, Geo Port, or Small Computer Systems Interface (SCSI), as examples.

Additionally, the information handling system 500 includes a memory 504. In one embodiment, memory 504 is provided on SIMMs (Single In-line Memory Modules), while in another embodiment, memory 504 is provided on DIMMs (Dual In-line Memory Modules), each of which plugs into suitable sockets provided on a motherboard holding many of the other devices shown in FIG. 5. Memory 504 includes standard DRAM (Dynamic Random-Access Memory), EDO (Extended Data Out) DRAM, SDRAM (Synchronous DRAM), or other suitable memory technology. Memory 504 may also include auxiliary memory to provide storage of instructions and data that are loaded into the memory 504 before execution. Auxiliary memory may include semiconductor based memory such as read-only memory (ROM), programmable read-only memory (PROM) erasable programmable read-only memory (EPROM), electrically erasable read-only memory (EEPROM), or flash memory (block oriented memory similar to EEPROM).

The information handling system 500 may include a network connection device or a network interface 506. The network interface 506 communicates between the information handling system 500 and a remote device, such as external devices, networks, information sources, or host systems that administer a plurality of information appliances. For example, host systems such as a server or information handling system, may run software controlling the information handling system 500, serve as storage for an information handling system 500, or coordinate software running separately on each information handling system 500. The network interface 506 may provide or receive analog, digital, or radio frequency data. The network interface system 506 preferably implements industry promulgated architecture standards, including Recommended Standard 232 (RS-232) promulgated by the Electrical Industries Association, Infrared Data Association (IrDA) standards, Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, 802.66 for wireless networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and Universal Serial Bus (USB), as examples. For example, the network interface system 506 may comprise a network adapter, a serial port, parallel port, printer adapter, modem, universal asynchronous receiver-transmitter (UART) port, etc., or use various wireless technologies or links such as an infrared port, radio-frequency (RF) communications adapter, infrared transducers, or RF modem.

The information handling system 500 may preferably include a display system 512. This may allow for a generation of a display when an information handling system 500 is connected to a display device. The display system 512 may comprise a video display adapter having all of the devices for driving the display device, including video random access memory (VRAM), buffer, and graphics engine as desired. A display device may comprise a liquid-crystal display (LCD), or may comprise alternative display technologies, such as a light-emitting diode (LED) display, gas or plasma display, or employ flat-screen technology.

An information handling system 500 may further include an input/output (I/O) system 516. This may allow for user input via I/O devices when I/O devices are connected to information handling system 500. Input/output system 516 may comprise one or more controllers or adapters for providing interface functions between one or more I/O devices. For example, input/output system 516 may comprise a serial port, parallel port, network adapter, printer adapter, radio-frequency (RF) communications adapter, universal asynchronous receiver-transmitter (UART) port, etc., for interfacing between corresponding I/O devices such as a mouse, joystick, trackball, trackpad, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, touch screen, stylus, electroacoustic transducer, microphone, speaker, etc. It should be appreciated that modification or reconfiguration of the information handling system 500 of FIG. 5 by a person of ordinary skill in the art would not depart from the scope or the intent of the present invention.

While the terms build to order system and build to order configuration have been utilized in the description of the invention, it is contemplated that each may refer to any assembly of components. Additionally, while an embodiment of the invention may refer to build to order computer systems, it is contemplated that various types of build to order systems may be utilized in accordance with the present invention without departing from the scope and intent of the present invention.

It is believed that the system and method of the present invention and many of its attendant advantages will be understood by the forgoing description. It is also believed that it will be apparent that various changes may be made in the form, construction and arrangement of the components thereof without departing from the scope and intent of the invention or without sacrificing all of its material advantages. The form herein before described being merely an explanatory embodiment thereof. It is the intention of the following claims to encompass and include such changes.

What is claimed is:

1. A method for selling a returned build to order system, comprising:
(a) detecting an identification of a system;
(b) retrieving a bill of materials for said system based upon said identification; and
(c) referencing said bill of materials for said system with a list of purchase orders,
wherein a purchase order from among said list of purchase orders is fulfilled with said system when said purchase order matches said bill of materials for said system.

2. The method as claimed in claim 1, further comprising testing said system to ensure system is operable.

3. The method as claimed in claim 1, wherein said detecting said identification of said system includes scanning a bar code of said system.

4. The method as claimed in claim 1, wherein said bar code is representative of a serial number of said system.

5. The method as claimed in claim 1, further comprising issuing a new serial number to said system fulfilling said purchase order.

6. The method as claimed in claim 1, further comprising updating a database with a new serial number, said bill of materials, and a new customer information.

7. The method as claimed in claim 1, wherein said bill of materials comprises a list of components within said system.

8. The method as claimed in claim 1, further comprising evaluating a closeness of said purchase order matching said bill of materials using an estimated cost to reconfigure the system to be an exact match to said purchase order.

9. A system for selling a returned build to order configuration, comprising:
(a) means for detecting an identification of a configuration;
(b) means for retrieving a bill of materials for said system based upon said identification; and
(c) means for referencing said bill of materials for said system with a list of purchase orders, wherein a purchase order from among said list of purchase orders is fulfilled with said system when said purchase order matches said bill of materials for said system.

10. The system as claimed in claim 9, wherein said means for detecting said identification of said configuration includes a bar code reader.

11. The system as claimed in claim 10, wherein said identification is a serial number of said configuration.

12. The system as claimed in claim 9, further comprising means for issuing a new serial number to said configuration fulfilling said purchase order.

13. The system as claimed in claim 9, further comprising means for updating a database with a new serial number, said bill of materials, and a new customer information.

14. The system as claimed in claim 9, wherein said bill of materials comprises a list of components within said system.

15. The system as claimed in claim 9, further comprising a memory for storing estimated costs to be used in evaluating a closeness of said purchase order matching said bill of materials based on the estimated costs to reconfigure the configuration to be an exact match to said purchase order.

16. A method for selling a returned build to order system, comprising:
(a) detecting an identification of a system;
(b) retrieving a bill of materials for said system based upon said identification;
(c) referencing said bill of materials for said system with a list of purchase orders;
(d) fulfilling a purchase order when said purchase order matches said bill of materials for said system; and
(e) offering said system to a potential customer when said bill of materials does not match said list of purchase orders.

17. The method as claimed in claim 16, wherein said detecting said identification of said system includes scanning a bar code of said system.

18. The method as claimed in claim 16, wherein said bar code is representative of a serial number of said system.

19. The method as claimed in claim 16, further comprising testing said system to ensure system is operable.

20. The method as claimed in claim 16, further comprising issuing a new serial number to said system in fulfilling said purchase order with said system.

21. The method as claimed in claim 16, further comprising updating a database with a new serial number, said bill of materials, and a new customer information.

22. The method as claimed in claim 16, wherein said system is offered to said potential customer when a potential purchase request is similar to said bill of materials.

23. The method as claimed in claim 16, wherein said bill of materials comprises a list of components within said system.
